(19) United States
(12) Patent Application Publication
(10) Pub. No.: US 2020/0144644 A1
(43) Pub. Date: May 7, 2020

(54) FUEL CELL SYSTEM

(71) Applicant: TOYOTA JIDOSHA KABUSHIKI KAISHA, Toyota-shi (JP)

(72) Inventors: Tomio YAMANAKA, Nagoya-shi (JP); Tomotaka ISHIKAWA, Nagoya-shi (JP)

(21) Appl. No.: 16/585,111

(22) Filed: Sep. 27, 2019

(30) Foreign Application Priority Data
Nov. 5, 2018 (JP) 2018-207973

(51) Int. Cl. H01M 8/04828; H01M 8/04701; H01M 8/04029; H01M 8/04119; H01M 8/0438; H01M 8/04746; H01M 8/04089

(52) U.S. Cl. CPC H01M 8/04843; H01M 8/04701; H01M 8/04029; H01M 8/04097; H01M 8/04402; H01M 8/04761; H01M 8/04395; H01M 8/04119

(57) ABSTRACT

A fuel cell system comprises a fuel cell, coolant, a gas-liquid separator, a gas-liquid discharge valve, and a controller. The controller includes an exhaust speed acquisition unit configured to obtain an exhaust speed A of anode off gas discharged from the gas-liquid discharge valve, a threshold speed setting unit configured to set an exhaust speed B, serving as a threshold speed, based on an exhaust speed A1 obtained in a warmed-up state in which temperature of the coolant is equal to or higher than predetermined temperature, and a gas-liquid discharge valve normality determination unit configured to compare an exhaust speed A2, obtained at the time after the exhaust speed B is set by the threshold speed setting unit and when environmental temperature is below zero, with the set threshold speed so as to perform a normal valve opening determination to determine whether the gas-liquid discharge valve opens normally.

### CROSS REFERENCE TO RELATED APPLICATIONS

The present application claims priority to Japanese Patent Application No. 2018-207973, filed on Nov. 5, 2018, the contents of which are incorporated herein by reference in their entirety.

### BACKGROUND

### Field

The present disclosure relates to a fuel cell system.

### Related Art

As disclosed in JP 2008-59974A, technology of a fuel cell system including a gas-liquid discharge valve configured to discharge impurity gas such as nitrogen gas included in anode off gas discharged from a fuel cell and liquid water generated by power generation by the fuel cell, to the outside, has been known.

According to the conventional technology, it is determined that opening operation of the gas-liquid discharge valve can be performed normally when temperature of the gas-liquid discharge valve is equal to or higher than thawing temperature. However, even if the temperature of the gas-liquid discharge valve is equal to or higher than the thawing temperature, the opening operation of the gas-liquid discharge valve may not be performed normally. For example, when a foreign substance such as dust is stuck in the gas-liquid discharge valve, the gas-liquid discharge valve may not be in a normal open state even if the temperature of the gas-liquid discharge valve is equal to or higher than the thawing temperature. In addition, for example, when the foreign substance is ice, the opening operation of the gas-liquid discharge valve may not be performed normally due to remaining ice that does not thaw completely even if the temperature of the gas-liquid discharge valve is equal to or higher than the thawing temperature. Therefore, determination based on the temperature of the gas-liquid discharge valve unfortunately results in inaccurate determination of whether the gas-liquid discharge valve can open normally.

### SUMMARY

According to one aspect of the present disclosure, there is provided a fuel cell system. The fuel cell system comprises a fuel cell, coolant configured to adjust temperature of the fuel cell, a gas-liquid separator configured to separate gas and moisture included in anode off gas discharged from the fuel cell, a gas-liquid discharge valve disposed downstream of the gas-liquid separator and configured to control discharge of the moisture from the gas-liquid separator, and a controller. The controller includes an exhaust speed acquisition unit configured to obtain an exhaust speed of the anode off gas discharged from the gas-liquid discharge valve as an exhaust speed A, a threshold speed setting unit configured to set an exhaust speed B, serving as a threshold speed, based on an exhaust speed A1 that is the exhaust speed A obtained by the exhaust speed acquisition unit in a warmed-up state in which temperature of the coolant is equal to or higher than predetermined temperature, and a gas-liquid discharge valve normality determination unit configured to compare an exhaust speed A2, which is the exhaust speed A at the time after the exhaust speed B is set by the threshold speed setting unit and when environmental temperature is below zero, with the exhaust speed B so as to perform a normal valve opening determination to determine whether the gas-liquid discharge valve opens normally.

### BRIEF DESCRIPTION OF THE DRAWINGS

FIG. 1 is a block diagram illustrating a schematic configuration of a fuel cell system according to a first embodiment.

FIG. 2 is a conceptual diagram illustrating an electrical configuration of the fuel cell system.

FIG. 3 is a flowchart illustrating normal valve opening determination processing according to the first embodiment.

FIG. 4 is a flowchart illustrating below-zero startup processing.

FIG. 5 is a graph illustrating characteristics of a gas-liquid discharge valve in an open state.

FIG. 6 is a flowchart illustrating threshold speed updating processing according to the first embodiment.

FIG. 7 is an explanatory diagram illustrating gas compositions of anode off gas in a warmed-up state and at below-zero startup.

FIG. 8 is a flowchart illustrating a threshold speed updating processing according to a second embodiment.

FIG. 9 is a flowchart illustrating a normal valve opening determination processing according to the second embodiment.

### DETAILED DESCRIPTION

Embodiments of the present disclosure are described hereinafter. Note that the following embodiments are examples and thus the present disclosure is not limited to these embodiments.

### A. First embodiment

### A1. System Configuration

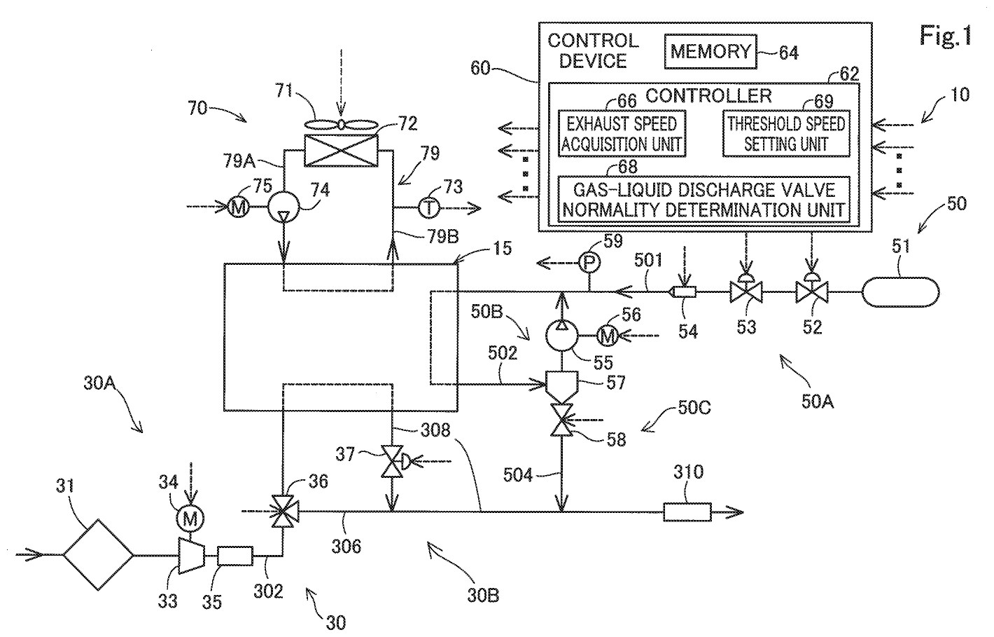

FIG. 1 is a block diagram illustrating a schematic configuration of a fuel cell system 10 according to a first embodiment. The fuel cell system 10 in the present embodiment is mounted on a fuel cell vehicle to supply electricity to a drive motor. The fuel cell system 10 includes a fuel cell 15, an oxidizing gas supply-discharge system 30, a fuel gas supply-discharge system 50, a coolant circulation system 70, and a control device 60.

The control device 60 includes a controller 62 and a memory 64. The controller 62 is configured to execute various programs stored in the memory 64 so as to control operation of the fuel cell system 10. For example, the controller 62 executes normal valve opening determination processing to determine whether operation of a gas-liquid discharge valve 58 is normal, as described later. The memory 64 is configured to store various thresholds such as a threshold speed used for the normal valve opening determination processing or the like, as well as the various programs.

The fuel cell 15 is what is known as a polymer electrolyte fuel cell and includes a cell stack formed of a plurality of unit cells (unit cells 151 that will be described later) stacked one on top of another along a stacking direction, a pair of current collector plates disposed on both ends of the cell stack to function as general electrodes, and end plates disposed outside of the respective current collector plates in the stacking direction. Each of the plurality of unit cells generates electricity through electrochemical reaction between fuel gas and oxidizing gas respectively supplied to an anode side catalyst electrode layer and a cathode side catalyst electrode layer sandwiching a solid polymer electrolyte membrane. In the present embodiment, the fuel gas is hydrogen gas, and the oxidizing gas is air. The catalyst electrode layer includes a catalyst such as carbon particles carrying platinum. A gas diffusion layer, formed of a porous body, is disposed outside of each of the catalyst electrode layers on both electrode sides in each of the unit cells. The porous body to be used is, for example, a carbon porous body, such as carbon paper and carbon cloth. In the fuel cell 15, a manifold is formed along the stacking direction, in order for the fuel gas and the oxidizing gas to flow in the manifold. The end plates each have a substantially plate-like outer shape with its thickness direction corresponding to the stacking direction. The end plates are configured to sandwich the cell stack and the pair of current collector plates and provide a flow path through which the fuel gas and the oxidizing gas are supplied to the manifold in the cell stack and media of these gases are discharged. The electricity output from the fuel cell 15 is supplied to a load device. In the present embodiment, the load device means the aforementioned drive motor, various auxiliary machines, or the like. The load device is electrically connected to each of the current collector plates of the fuel cell 15 on a cathode side and an anode electrode side.

The oxidizing gas supply-discharge system 30 is configured to supply the oxidizing gas to the fuel cell 15 and discharge cathode off gas from the fuel cell 15. The oxidizing gas supply-discharge system 30 includes an oxidizing gas supply system 30A and an oxidizing gas discharge system 30B. The oxidizing gas supply system 30A is configured to supply the oxidizing gas to the fuel cell 15. The oxidizing gas supply system 30A includes an oxidizing gas supply path 302, an air cleaner 31, a compressor 33, a motor 34, an intercooler 35, and a flow dividing valve 36.

The oxidizing gas supply path 302 is configured as piping disposed on an upstream side of the fuel cell 15 to connect the outside with a cathode of the fuel cell 15 in a communicating manner. The air cleaner 31 is disposed in the oxidizing gas supply path 302 on an upstream side of the compressor 33 and configured to remove foreign substances from the oxidizing gas to be supplied to the fuel cell 15. The compressor 33 is disposed on an upstream side of the fuel cell 15 and configured to discharge compressed air toward the cathode according to an instruction from the controller 62. The compressor 33 is driven by the motor 34 operating according to an instruction from the controller 62. The intercooler 35 is disposed in the oxidizing gas supply path 302 on a downstream side of the compressor 33. The intercooler 35 is configured to cool the oxidizing gas that is hot due to compression by the compressor 33. The flow dividing valve 36 is configured as, for example, a three-way valve an opening degree of which is adjusted to control a flow rate of the oxidizing gas flowing from the oxidizing gas supply path 302 toward the fuel cell 15 and a flow rate of the oxidizing gas flowing in a bypass 306 that branches off from the oxidizing gas supply path 302 so as not to pass through the fuel cell 15. The oxidizing gas flowing in the bypass 306 flows through an oxidizing gas discharge path 308 to go out into the atmosphere.

The oxidizing gas discharge system 30B is configured to discharge the oxidizing gas. The oxidizing gas discharge system 30B includes the oxidizing gas discharge path 308, the bypass 306, and a pressure control valve 37. The oxidizing gas discharge path 308 includes piping configured to discharge the cathode off gas including the oxidizing gas discharged from the fuel cell 15 and the oxidizing gas flowing through the bypass 306, into the atmosphere. The pressure control valve 37 is configured to have its degree of opening adjusted so as to control back pressure in a cathode side flow path of the fuel cell 15. The pressure control valve 37 is disposed in the oxidizing gas discharge path 308 on an upstream side of a connecting part with the bypass 306. At a downstream end of the oxidizing gas discharge path 308, a muffler 310 is disposed.

The fuel gas supply-discharge system 50 includes a fuel gas supply system 50A, a fuel gas circulation system 50B, and a fuel gas discharge system 50C.

The fuel gas supply system 50A is configured to supply the fuel gas to the fuel cell 15. The fuel gas supply system 50A includes a fuel gas tank 51, a fuel gas supply path 501, a main stop valve 52, a regulator 53, an injector 54, and a pressure sensor 59. The fuel gas tank 51 is configured to store high-pressure hydrogen gas, for example. The fuel gas supply path 501 is configured as piping connected to the fuel gas tank 51 and the fuel cell 15. The fuel gas from the fuel gas tank 51 toward the fuel cell 15 flows through the piping. The main stop valve 52 is configured to allow the fuel gas in the fuel gas tank 51 to flow downstream when it is open. The regulator 53 is configured to adjust pressure of the fuel gas on an upstream side of the injector 54 according to control by the controller 62. The injector 54 is disposed in the fuel gas supply path 501 on an upstream side of a joining place with a fuel gas circulation path 502 described later. The injector 54 is configured as an on-off valve electromagnetically driven according to a driving period or valve opening time set by the controller 62 so as to adjust a supply amount of the fuel gas to the fuel cell 15. The pressure sensor 59 is configured to measure inner pressure in the fuel gas supply path 501 on a downstream side of the injector 54. A measured value is transmitted to the control device 60 to be used in normal valve opening determination processing and threshold speed updating processing, described later, and also in injection control of the fuel gas or the like.

The fuel gas circulation system 50B is configured to circulate anode off gas discharged from the fuel cell 15 into the fuel gas supply path 501. The fuel gas circulation system 50B includes the fuel gas circulation path 502, a gas-liquid separator 57, a circulation pump 55, and a motor 56. The fuel gas circulation path 502 is configured as piping connected to the fuel cell 15 and the fuel gas supply path 501. The anode off gas toward the fuel gas supply path 501 flows through the piping. The gas-liquid separator 57 is disposed in the fuel gas circulation path 502 and configured to separate liquid water from the anode off gas including water. The circulation pump 55 is configured to circulate the anode off gas in the fuel gas circulation path 502 toward the fuel gas supply path 501 by driving the motor 56. The circulation pump 55 corresponds to a fuel gas circulation pump in the present disclosure.

The fuel gas discharge system 50C is configured to discharge the anode off gas and water generated by power generation by the fuel cell 15 into the atmosphere. The fuel gas discharge system 50C includes a gas-liquid discharge path 504 and a gas-liquid discharge valve 58. The gas-liquid discharge path 504 is configured as piping to connect an outlet of the gas-liquid separator 57, from which water is discharged, and the oxidizing gas discharge path 308 in a communicating manner.

The gas-liquid discharge valve 58 is disposed in the gas-liquid discharge path 504 and configured to open and close the gas-liquid discharge path 504. As for the gas-liquid discharge valve 58, a diaphragm valve is adopted, for example. In a normal operation state of the fuel cell system 10 where it is determined that the gas-liquid discharge valve 58 is open normally, the controller 62 executes normal exhaust processing in which the controller 62 instructs the gas-liquid discharge valve 58 to open at predetermined timing and controls the injector 54 to open and close so as to supply the fuel gas to a downstream side. Accordingly, the gas-liquid discharge valve 58 opens, so that nitrogen gas, which is impurity gas included in the anode off gas, is discharged outside through the gas-liquid discharge path 504 and the oxidizing gas discharge path 308 along with water. The predetermined timing is timing when an amount of accumulated water in the gas-liquid separator 57 becomes equal to or higher than a predetermined amount of liquid water, for example. Note that the circulation pump 55 may be driven or stopped in the normal exhaust processing.

The coolant circulation system 70 is configured to adjust temperature of the fuel cell 15 using coolant. Examples of the coolant to be used include water, nonfreezing fluid such as ethylene glycol. The coolant circulation system 70 includes a coolant circulation path 79, a coolant circulation pump 74, a motor 75, a radiator 72, a radiator fan 71, and a temperature sensor 73.

The coolant circulation path 79 includes a coolant supply path 79A and a coolant discharge path 79B. The coolant supply path 79A is configured as piping to supply the coolant to the fuel cell 15. The coolant discharge path 79B is configured as piping to discharge the coolant from the fuel cell 15. The coolant circulation pump 74 is configured to send the coolant in the coolant supply path 79A to the fuel cell 15 by driving the motor 75. The radiator 72 is configured to radiate heat by wind sent from the radiator fan 71 so as to cool the coolant flowing inside. The temperature sensor 73 is configured to measure temperature of the coolant in the coolant discharge path 79B. A measured value of the temperature of the coolant is transmitted to the control device 60.

The controller 62 includes a central processing unit (CPU), not shown. The CPU is configured to execute programs previously stored in the memory 64 so as to function as an exhaust speed acquisition unit 66, a gas-liquid discharge valve normality determination unit 68, and a threshold speed setting unit 69. The exhaust speed acquisition unit 66 is configured to calculate an exhaust speed of the anode off gas discharged from the gas-liquid discharge valve 58 using a change in pressure obtained from the pressure sensor 59 so as to obtain an exhaust speed A. A method for calculating the exhaust speed will be described later. The gas-liquid discharge valve normality determination unit 68 is configured to make a normal valve opening determination of the gas-liquid discharge valve 58 using an exhaust speed A2 obtained by the exhaust speed acquisition unit 66. The exhaust speed A2 means an exhaust speed A obtained by the exhaust speed acquisition unit 66 when environmental temperature is below zero, as will be described later. The normal valve opening determination will be described later. The threshold speed setting unit 69 is configured to set a threshold speed. The threshold speed means an exhaust speed B to be compared with the exhaust speed A2 obtained by the exhaust speed acquisition unit 66 in the normal valve opening determination. Details of the threshold speed will be described later. The reference numerals “A”, “A2”, “B” described above and “A1” described below are used just for convenience to distinguish the same term “exhaust speed”.

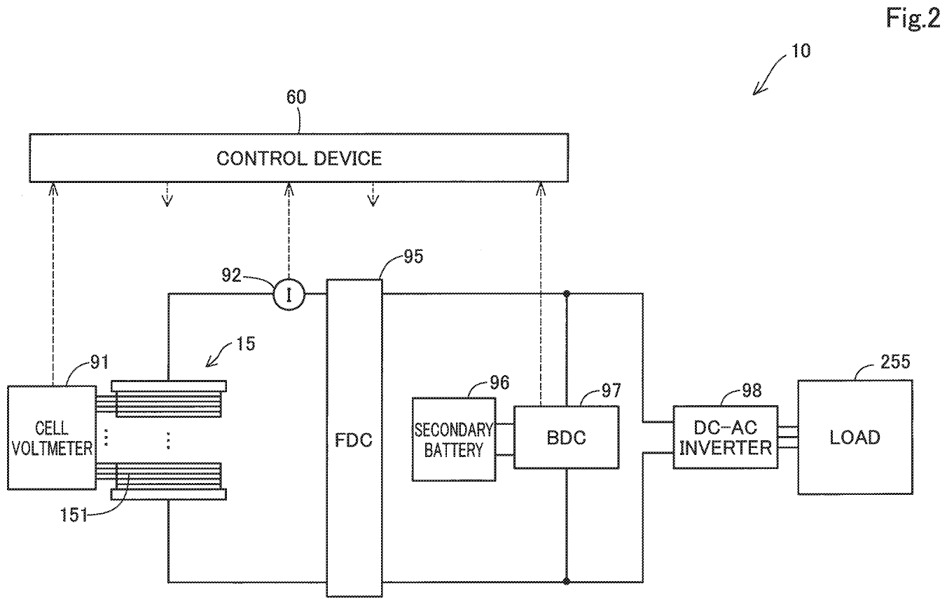

FIG. 2 is a conceptual diagram illustrating an electrical configuration of the fuel cell system 10. The fuel cell system 10 includes an FDC 95, a DC-AC inverter 98, a cell voltmeter 91, and a current sensor 92.

The cell voltmeter 91 is configured to measure cell voltage of each of the plurality of unit cells 151 of the fuel cell 15. The cell voltmeter 91 transmits measured values to the control device 60. The current sensor 92 is configured to measure output current from the fuel cell 15 and transmit a measured value to the control device 60.

The FDC 95 is configured as a circuit to serve as a DC-AC converter. The FDC 95 controls its output voltage according to a voltage instruction value transmitted from the control device 60. In addition, the FDC 95 controls output current from the fuel cell 15 according to a current instruction value transmitted from the control device 60. The current instruction value is a target value of the output current from the fuel cell 15 and is set by the control device 60. For example, the control device 60 calculates the current instruction value using required electric energy of the fuel cell 15 so as to generate the current instruction value.

The DC-AC inverter 98 is connected to the fuel cell 15 and a load 255. The DC-AC inverter 98 is configured to convert direct current output from the fuel cell 15 into alternating current and supply it to the load 255.

The fuel cell system 10 further includes a secondary battery 96 and a BDC 97. The secondary battery 96 is formed from, for example, a nickel hydrogen battery or a lithium ion battery. The secondary battery is configured to function as an auxiliary power supply. Moreover, the secondary battery 96 is configured to supply electricity to the fuel cell 15 and take in electricity generated by the fuel cell 15 and regenerated electricity. The BDC 97 is configured as a circuit to serve as a DC-AC converter together with the FDC 95 and control charging and discharging of the secondary battery 96 according to an instruction from the controller 62. The BDC 97 measures an SOC (State Of Charge) of the secondary battery 96 and transmits it to the control device 60.

### A2. Normal Valve Opening Determination Processing

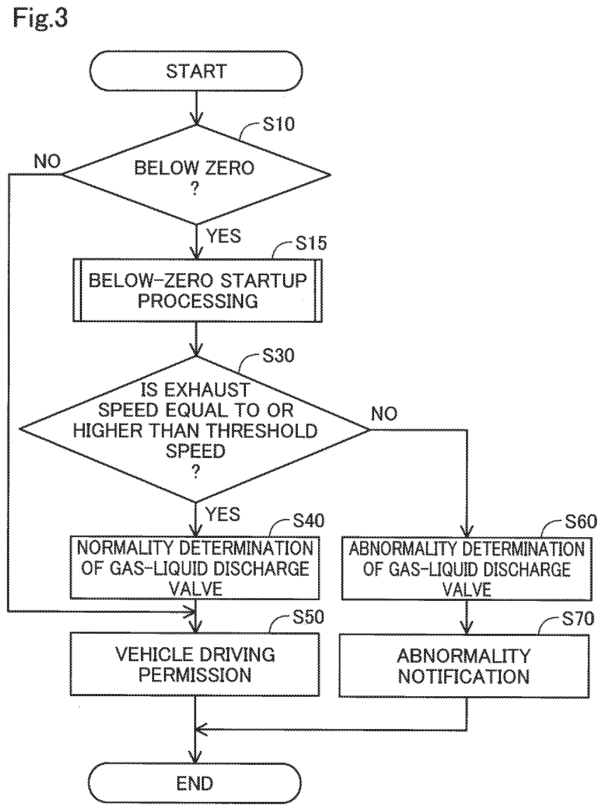

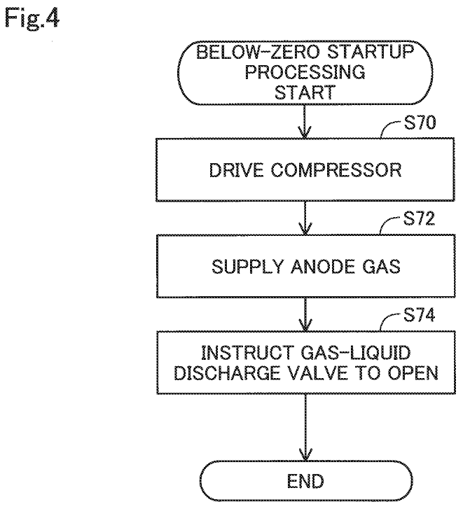

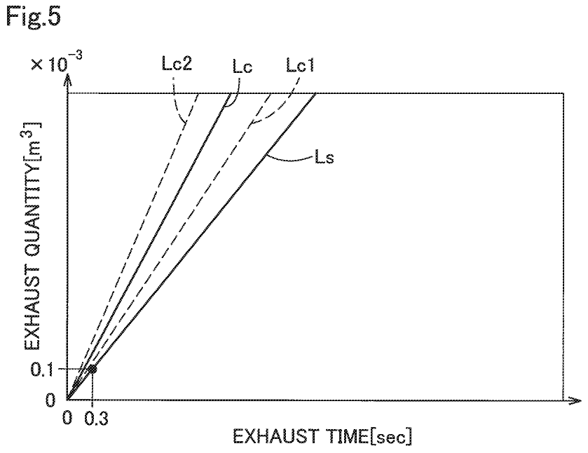

FIG. 3 is a flowchart illustrating a normal valve opening determination processing according to the first embodiment. The normal valve opening determination processing determines whether the gas-liquid discharge valve 58 opens normally. In the present embodiment, the normal valve opening determination processing is executed at startup when a start switch of a fuel cell vehicle is turned on and the fuel cell system 10 receives an activation instruction. Note that the normal valve opening determination processing may be executed at predetermined timing after the startup. FIG. 4 is a flowchart illustrating below-zero startup processing. FIG. 5 is a graph illustrating characteristics of the gas-liquid discharge valve 58 in an open state. In FIG. 5, a vertical axis represents an exhaust quantity of the anode off gas discharged from the gas-liquid discharge valve 58, and a horizontal axis represents exhaust time.

As shown in FIG. 3, the controller 62 determines whether environmental temperature is below zero (step S10). The environmental temperature is temperature of environment where the fuel cell system 10 is disposed. In the present embodiment, the environmental temperature is the temperature of the coolant in the coolant discharge path 79B obtained by the temperature sensor 73 shown in FIG. 1. Note that the environmental temperature may be temperature of outside air or the gas-liquid discharge valve 58 in other embodiments. The temperature of the outside air can be obtained by disposing an outer temperature sensor, for example. The temperature of the gas-liquid discharge valve 58 can be obtained by disposing a temperature sensor near the gas-liquid discharge valve 58, for example.

If it is determined that the environmental temperature is not below zero in the step S10 (step S10: NO), the controller 62 notifies a driver of a driving permission of the vehicle (step S50). In the step S50, the driving permission is notified to the driver by displaying information that the fuel cell vehicle is in an operable state on a monitor or the like in the fuel cell vehicle. On the other hand, if it is determined that the environmental temperature is below zero in the step S10 (step S10: YES), the controller 62 executes below-zero startup processing (step S15). The below-zero startup processing is processing to secure a required power generation amount of the fuel cell 15 even if the fuel cell 15 freezes.

As shown in FIG. 4, the controller 62 drives the compressor 33 in the below-zero startup processing (step S70). Next, the controller 62 controls opening and closing of the injector 54 so as to supply anode gas to the fuel cell 15 (step S72). In the step S72, while the anode gas is supplied to the fuel cell 15, the circulation pump 55 is stopped in order to replace gas in an anode of the fuel cell 15 with anode gas. The controller 62 transmits a valve opening instruction to the gas-liquid discharge valve 58 (step S74). The below-zero startup processing continues until supplied quantity of the anode gas to the anode of the fuel cell 15 becomes equal to or higher than capacity of the anode. The supplied quantity of the anode gas is calculated using a pressure value measured by the pressure sensor 59.

As shown in FIG. 3, when the gas-liquid discharge valve 58 receives the valve opening instruction, the controller 62 determines whether the exhaust speed A2 of the anode off gas discharged from the gas-liquid discharge valve 58 is equal to or higher than a predetermined threshold speed (step S30). In the step S30, a comparison between the exhaust speed of the anode off gas and the predetermined threshold speed may be made using the exhaust speed based on a mass flow rate or a volume flow rate.

The threshold speed is stored in the memory 64. The threshold speed is updated in threshold speed updating processing described later. Details of an initial value of the threshold speed and the threshold speed updating processing will be described later. As shown in FIG. 5, a threshold speed Ls [m³/sec] is set to a value lower than a designed value Lc [m³/sec] of the exhaust speed at the time when the gas-liquid discharge valve 58 is open. The designed value Lc is a value when an opening rate of the gas-liquid discharge valve 58 is 100%. The opening rate is a proportion (%) of an actual cross-sectional area (opening area) of a flow path of the gas-liquid discharge valve 58 with respect to a cross-sectional area of the flow path of the gas-liquid discharge valve 58 when the gas-liquid discharge valve 58 has no malfunction and is open as designed. The threshold speed Ls is set to an exhaust speed that can reach a target exhaust speed that is an accumulated value of the anode off gas exhausted in the normal exhaust processing at target supply pressure of the fuel gas when predetermined time has elapsed since the controller 62 transmitted the valve opening instruction to the gas-liquid discharge valve 58. For example, the threshold speed Ls is set to the exhaust speed at the time when the opening rate of the gas-liquid discharge valve 58 is 50%. In the present embodiment, when the opening rate is 50%, assuming that the temperature of the fuel cell 15 measured by the temperature sensor 73 is 0° C. and the target supply pressure of the fuel gas is 200 kPa, target exhaust quantity of the anode off gas in the normal exhaust processing is 0.1 L. The predetermined time is determined in consideration of surplus time needed to stabilize the measured value by the pressure sensor 59 in addition to time to reach the target exhaust quantity 0.1 L when the opening rate of the gas-liquid discharge valve 58 is 50%, for example. The predetermined time in the present embodiment is 0.3 sec., for example. That is, the threshold speed Ls is set to 0.1 L/0.3 sec. The threshold speed Ls may be changed depending on the temperature of the fuel cell and the target supply pressure of the fuel gas.

A referential character Lc1 shown in FIG. 5 represents a designed value of the exhaust speed at the time when the gas-liquid discharge valve 58 is in the open state with the smallest opening area and the lowest exhaust speed within a design tolerance of the gas-liquid discharge valve 58. On the other hand, a referential character Lc2 represents a designed value of the exhaust speed at the time when the gas-liquid discharge valve 58 is in the open state with the largest opening area and the highest exhaust speed within the design tolerance of the gas-liquid discharge valve 58. As shown in FIG. 5, the exhaust speed Lc at 100% of the opening rate of the gas-liquid discharge valve 58 varies between the exhaust speed Lc1 and Lc2 in consideration of the design tolerance. Accordingly, in the present embodiment, an initial value of the threshold speed Ls is set based on the exhaust speed Lc1 at the time when the gas-liquid discharge valve 58 with the lowest exhaust speed within the design tolerance is open at 100% of the opening rate. For example, the threshold speed Ls is set to speed reduced by a predetermined percentage from the exhaust speed Lc1. The predetermined percentage may be set to any value such as 20%, for example. Setting the initial value of the threshold speed Ls as described above can suppress an erroneous determination that an opening of the gas-liquid discharge valve 58 is blocked because the small opening area makes the exhaust speed of the gas-liquid discharge valve 58 lower than the threshold speed, even though the opening of the gas-liquid discharge valve 58 is not blocked. Note that the initial value of the threshold speed Ls does not have to be set based on the exhaust speed Lc1, but may be set based on any value between the exhaust speed Lc1 and the Lc2, inclusive.

The exhaust speed A2 is obtained by the exhaust speed acquisition unit 66. In the present embodiment, the exhaust speed acquisition unit 66 calculates and obtains the exhaust speed A2 by Formulas (1) to (4) below using time information of a timer, not shown, and a measured value of the pressure sensor 59.

Pv=f(Qᵢₙ−Q_{crs}−Q_{FC}−Qₑₓ) Formula (1)

Here, Pv represents a pressure reduction speed [Pa/sec] of the fuel gas in the fuel gas supply path 501. Pv is calculated by differentiating the measured value by the pressure sensor 59 with respect to time. In addition, Qᵢₙ represents a supply flow rate [m³/sec] of the fuel gas supplied toward a downstream side from the injector 54, Q_{crs} represents a hydrogen permeation speed [m³/sec] from the anode to the cathode of the fuel cell 15, Q_{FC} represents a consuming speed [m³/sec] of the fuel gas consumed by power generation of the fuel cell 15, Qₑₓ represents the exhaust speed A2 [m³/sec] discharged from the gas-liquid discharge valve 58, and f represents a predetermined function. Qᵢₙ, Q_{crs} and Q_{FC} are expressed in volume flow rate [m³/sec] of gas in a standard condition. Qᵢₙ is calculated by a formula of an orifice using a pressure difference in the flow path between the upstream side and the downstream side of the injector 54. The determination in the step S30 shown in FIG. 3 is preferably performed while operation of the injector 54 is stopped, that is, while the injector is closed. In this case, “0” is substituted for Qᵢₙ. Q_{crs} is calculated based on a difference in hydrogen partial pressure between both poles. When the determination in the step S30 is performed, the hydrogen permeation speed is very low. Therefore, Q_{crs} may be considered as “0”. While the operation of the injector 54 is stopped is, for example, while the operation of the injector 54 is stopped during so-called intermittent operation. The intermittent operation means operation in which hydrogen gas is intermittently supplied in order to suppress deterioration of a catalyst used in a catalyst layer in a light load status.

Q_{FC} is calculated by Formula (2) below:

Q_{FC}=(I/F)×(½)×N×22.4×10⁻³ Formula (2)

Here, I represents a measured current value [A] by the current sensor 92, F represents Faraday number, and N represents the number of stacked layers of the plurality of unit cells 151. 22.4×10⁻³ is volume per 1 mole of gas [m³/mol] in the standard condition.

By substituting “0” for Qᵢₙ and Q_{crs} in the foregoing Formula (1), following Formula (3) is derived, and Formula (4) is derived from the Formula (3).

Pv=f(−Q_{FC}−Qₑₓ) Formula (3)

Qₑₓ={V×(Pv/Ps)×(273/(273+T))}−Q_{FC} Formula (4)

In the Formula (4), V represents a volume [m³] where the fuel gas can flow on the downstream side of the injector 54 when the gas-liquid discharge valve 58 is closed. Specifically, it is a sum of the volumes of the fuel gas supply path 501 on the downstream side of the injector 54, the fuel gas circulation path 502, and the gas-liquid separator 57. In addition, Ps in the Formula (4) represents a standard pressure, which is 101.3 kPa in the present embodiment. Furthermore, T represents the environmental temperature [° C.] where the fuel cell system 10 is disposed. In the present embodiment, it is a measured value (Celsius) by the temperature sensor 73.

The controller 62 substitutes the forgoing Formula (2) in the foregoing Formula (4) so as to calculate the exhaust speed A (Qₑₓ). Note that Q_{FC} is “0” when the fuel cell 15 does not generate electricity.

In the step S30, the gas-liquid discharge valve normality determination unit 68 compares the exhaust speed A2 (Qₑₓ) with the threshold speed Ls so as to perform the normal valve opening determination of whether the gas-liquid discharge valve 58 opens normally. Specifically, if the calculated exhaust speed A2 (Qₑₓ) is equal to or higher than the threshold speed Ls (step S30: YES), the gas-liquid discharge valve normality determination unit 68 makes the normal valve opening determination that the gas-liquid discharge valve 58 is open normally (step S40). That is, the gas-liquid discharge valve normality determination unit 68 makes a normality determination if the exhaust speed A2 (Qₑₓ) from the gas-liquid discharge valve 58 is equal to or higher than the predetermined threshold speed Ls while the valve opening instruction is made to the gas-liquid discharge valve 58. The controller 62 executes the aforementioned step S50 after the step S40.

On the other hand, if the exhaust speed A2 (Qₑₓ) is lower than the threshold speed Ls (step S30: NO), the gas-liquid discharge valve normality determination unit 68 makes an abnormality determination that the gas-liquid discharge valve 58 is not open normally (step S60). That is, the gas-liquid discharge valve normality determination unit 68 makes the abnormality determination if the exhaust speed A2 (Qₑₓ) from the gas-liquid discharge valve 58 is lower than the predetermined threshold speed Ls while the valve opening instruction is made to the gas-liquid discharge valve 58. In this case, the controller 62 notifies the driver that abnormality occurs in the gas-liquid discharge valve 58 (step S70) and terminates the normal valve opening determination processing without giving the driving permission of the vehicle.

In the aforementioned normal valve opening determination processing, the set value of the threshold speed Ls is important to suppress decrease in determination accuracy. As described above, in the present embodiment, the initial value of the threshold speed Ls is set based on the exhaust speed Lc1 at the time when the gas-liquid discharge valve 58 with the smallest opening area within the design tolerance is open at 100% of the opening rate. However, as for one (gas-liquid discharge valve 58) with a relatively large opening area, it may be erroneously determined normal if such an initial value is used, even though the opening is partially blocked due to jamming by a foreign substance in fact. Moreover, if dirt and foreign substances are accumulated due to aging in the opening of the gas-liquid discharge valve 58 and the opening area is reduced, the initial value of the threshold speed may result in an inaccurate determination. Accordingly, in the present embodiment, the threshold speed is updated by threshold speed updating processing described later.

### A3. Threshold Speed Updating Processing

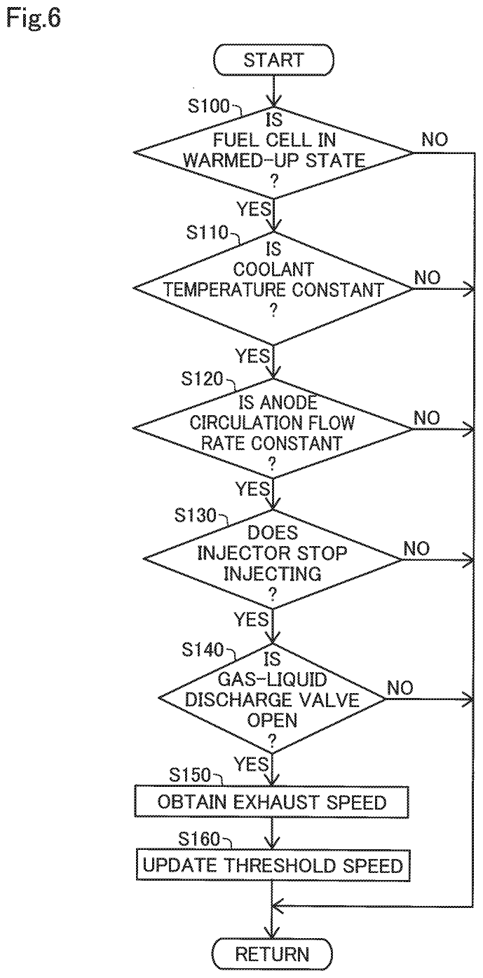

FIG. 6 is a flowchart illustrating the threshold speed updating processing according to the present embodiment. Threshold speed updating processing is executed at startup when the start switch of the fuel cell vehicle is turned on and the fuel cell system 10 receives an activation instruction.

The threshold speed setting unit 69 determines whether the temperature of the coolant (hereinafter simply referred to as “coolant temperature”) flowing in the coolant circulation path 79 measured by the temperature sensor 73 is equal to or higher than predetermined temperature (step S100). A state in which the coolant temperature is equal to or higher than the predetermined temperature is hereinafter referred to as a “warmed-up state”. Specifically, it is determined that the fuel cell 15 is in the warmed-up state when the coolant temperature becomes equal to or higher than 60° C. When the fuel cell vehicle is traveling, the coolant temperature can be equal to or higher than 60° C. due to waste heat of the fuel cell 15. In this case, an amount of saturated water vapor is larger than that in below-zero environment for example, so that most of water discharged from the fuel cell 15 is discharged as water vapor. Note that the threshold temperature for determination in the step S100 is not limited to 60° C., but may be set to any temperature of the coolant as long as most of water discharged from the gas-liquid discharge valve 58 becomes water vapor.

If it is determined that the fuel cell 15 is in the warmed-up state (step S100: YES), the threshold speed setting unit 69 determines whether the coolant temperature measured by the temperature sensor 73 for predetermined time is constant (step S110). If it is determined constant (step S110: YES), the threshold speed setting unit 69 determines whether a flow rate of the anode off gas flowing in the fuel gas circulation system 50B is constant (step S120). If it is determined constant (step S120: YES), the threshold speed setting unit 69 determines whether the injector 54 stops injecting hydrogen gas (step S130). The coolant temperature can be variable or constant depending on the number of revolutions of the coolant circulation pump 74 and traveling environment of the fuel cell vehicle. In addition, the flow rate of the anode off gas flowing in the fuel gas circulation system 50B can be constant when the number of revolutions of the coolant circulation pump 74 is constant. Moreover, the flow rate can also be constant when the coolant circulation pump 74 is stopped. Cases where the injector 54 stops injecting the hydrogen gas can occur during the intermittent operation, as described above, for example.

The threshold speed setting unit 69 determines whether the gas-liquid discharge valve 58 is open (step S140). In the present embodiment, the gas-liquid discharge valve 58 intermittently performs opening and closing operation. For example, the opening operation is performed for several hundred milliseconds (msec) to one second (sec) per one minute.

If it is determined that the gas-liquid discharge valve 58 is open (step S140: YES), the exhaust speed acquisition unit 66 obtains the exhaust speed A1 of the gas-liquid discharge valve 58 (step S150). The exhaust speed acquisition unit 66 calculates and obtains the exhaust speed A1, using the forgoing Formulas (1) to (4). The exhaust speed A1 means an exhaust speed A obtained by the exhaust speed acquisition unit 66 in the warmed-up state. The gas-liquid discharge valve 58 does not freeze and can open normally in the warmed-up state. Therefore, it can also be said that the exhaust speed A1 is the exhaust speed A in the normal state.

The threshold speed setting unit 69 calculates the exhaust speed B based on the exhaust speed A1 obtained in the step S150 so as to update the threshold speed to the exhaust speed B (step S160). After the step S160, the processing returns to the step S100. Accordingly, the threshold speed is repeatedly updated while requirements in the steps S110 to S140 are met. The threshold speed updated as described above will be used in the step S30 of the next normal valve opening determination processing.

If it is determined that the fuel cell 15 is not in the warmed-up state in the step S100 (step S100: NO), the coolant temperature is not constant in the step S110 (step S110: NO), an anode circulation flow rate is not constant in the step S120 (step S120: NO), the injector is injecting hydrogen gas in the step S130 (step S130: NO), or the gas-liquid discharge valve 58 is not open in the step S140 (step S140: NO), the processing returns to the step S100. Accordingly, the threshold speed is not updated in these cases.

According to the fuel cell system 10 in the first embodiment described above, the normal valve opening determination of the gas-liquid discharge valve 58 is executed using the exhaust speed B, thereby enabling an accurate determination of whether the gas-liquid discharge valve 58 opens normally. For example, the accurate determination can be made when the gas-liquid discharge valve 58 does not operate normally due to a reason other than freezing. Furthermore, for example, the normal valve opening determination using the exhaust speed A also enables an accurate normal valve opening determination even when the gas-liquid discharge valve 58 does not open normally due to freezing.

Moreover, the threshold speed setting unit 69 sets the exhaust speed B serving as the threshold speed based on the exhaust speed A1 obtained by the exhaust speed acquisition unit 66. Therefore, compared with a configuration in which the threshold speed is previously set to a predetermined value, it is possible to suppress the decrease in the determination accuracy of whether the gas-liquid discharge valve 58 opens normally when an individual difference or aging of the gas-liquid discharge valve 58 occurs. For example, compared with a configuration in which the predetermined value is previously set as the threshold speed even though the design tolerance causes a variation in opening areas of a plurality of gas-liquid discharge valves 58, or a configuration in which the predetermined value previously set as the threshold speed is continuously used even though the opening area is reduced due to aging such as adhesion of dirt to the opening of the gas-liquid discharge valve 58, the decrease in the determination accuracy can be suppressed.

Furthermore, the initial value of the threshold speed is set based on the exhaust speed Lc1 of the gas-liquid discharge valve 58 that is the lowest exhaust speed within the design tolerance of the opening area of the gas-liquid discharge valve 58. Therefore, it is possible to suppress an erroneous determination that the opening of the gas-liquid discharge valve 58 is blocked because the small opening area makes the exhaust speed lower than the threshold speed, even though the opening of the gas-liquid discharge valve 58 is not blocked.

Furthermore, the exhaust speed A1 is obtained in the warmed-up state, which makes it possible to set the threshold speed based on the exhaust speed A1 obtained when the freezing of the gas-liquid discharge valve 58 is suppressed. Accordingly, the threshold speed is set based on the exhaust speed A at the time when the gas-liquid discharge valve 58 does not freeze and can open normally, thereby suppressing the decrease in the determination accuracy of whether the gas-liquid discharge valve 58 opens normally. Moreover, since the coolant temperature is equal to or higher than the predetermined temperature in the warmed-up state, saturated water vapor pressure is high, and thus an amount of water vapor included in the anode off gas increases. Therefore, discharging liquid water from the gas-liquid discharge valve 58 is suppressed. Accordingly, it is possible to restrain the exhaust speed A from being set as the threshold speed (exhaust speed B), the exhaust speed A being obtained when the exhaust speed is lower than an actual capability value of the gas-liquid discharge valve 58 because liquid water discharged from the gas-liquid discharge valve 58 restrains gas from being exhausted. Therefore, an accurate value can be set as the threshold speed.

Moreover, the exhaust speed acquisition unit 66 calculates the exhaust speed A (exhaust speeds A1 and A2) using an amount of change in the gas pressure measured by the pressure sensor 59. Therefore, no additional device is required to obtain the exhaust speed. As a result, manufacturing costs for the fuel cell system can be reduced.

Furthermore, the exhaust speed A1 is calculated using the amount of change in the gas pressure measured by the pressure sensor 59 while the gas-liquid discharge valve 58 is open, the number of revolutions of the circulation pump 55 is constant, and supply of the fuel gas to the fuel gas supply path 501 by the injector 54 is stopped. Therefore, the exhaust speed A1 can be calculated using the amount of change in the gas pressure measured when the number of factors that vary the gas pressure in the fuel gas supply path 501 is few. Accordingly, the exhaust speed as actual capability of the gas-liquid discharge valve 58 in the normal state can be measured more accurately, thereby enabling more accurate determination of whether the gas-liquid discharge valve 58 is open normally.

### B. Second Embodiment

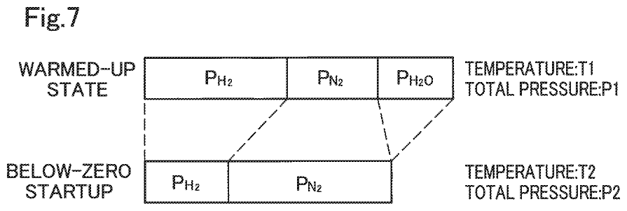

The configuration of the fuel cell system 10 in the second embodiment is the same as that of the fuel cell system 10 in the first embodiment, and thus components that are the same as those in the first embodiment are denoted with the same reference numerals and detailed descriptions thereof will be omitted. The fuel cell system 10 in the second embodiment is different from the fuel cell system 10 in the first embodiment in procedures of the normal valve opening determination processing and the threshold speed updating processing. In the fuel cell system 10 in the second embodiment, when the threshold speed updated in the threshold speed updating processing is used in the normal valve opening determination processing, threshold speed is corrected based on density of the anode off gas before use. Meaning of this correction of the threshold speed is hereinafter described with reference to FIG. 7.

FIG. 7 is an explanatory diagram illustrating gas compositions of the anode off gas in the warmed-up state and at below-zero startup. In the warmed-up state in which the threshold speed is updated, the environmental temperature is relatively high, so that the anode off gas includes water vapor. Accordingly, the anode off gas in the warmed-up state includes the hydrogen gas, the nitrogen gas, and the water vapor. The hydrogen gas is surplus hydrogen gas unused for electrochemical reaction in each of the unit cells 151. The nitrogen gas is nitrogen gas that permeates through the electrolyte membrane from the cathode side to the anode side in each of the unit cells 151 out of the oxidizing gas supplied to the fuel cell 15. The water vapor is water vapor produced from water that is generated on the cathode side by the electrochemical reaction in each of the unit cells 151 and permeates to the anode side through the electrolyte membrane.

On the other hand, an amount of saturated water vapor is small at the below-zero startup, and thus most of water discharged from the fuel cell 15 freezes or is discharged as liquid water. Therefore, the anode off gas at the below-zero startup includes approximately the hydrogen gas and the nitrogen gas only. The water vapor is included only to the extent that it can be ignored. Coolant temperature T1 in the warmed-up state is higher than coolant temperature T2 at the below-zero startup. In addition, a total pressure P1 in the warmed-up state is larger than a total pressure P2 at the below-zero startup in FIG. 7; however, it is not limited to this. Note that a partial pressure of the hydrogen P_{H2}, a partial pressure of the nitrogen P_{N2}, and a partial pressure of the water vapor P_{H2O} are shown for reference in FIG. 7.

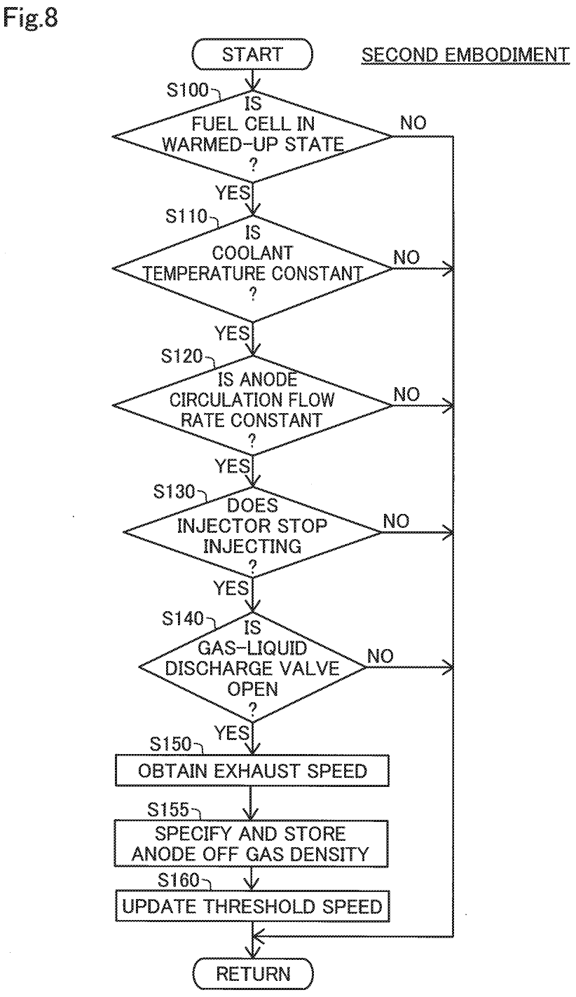

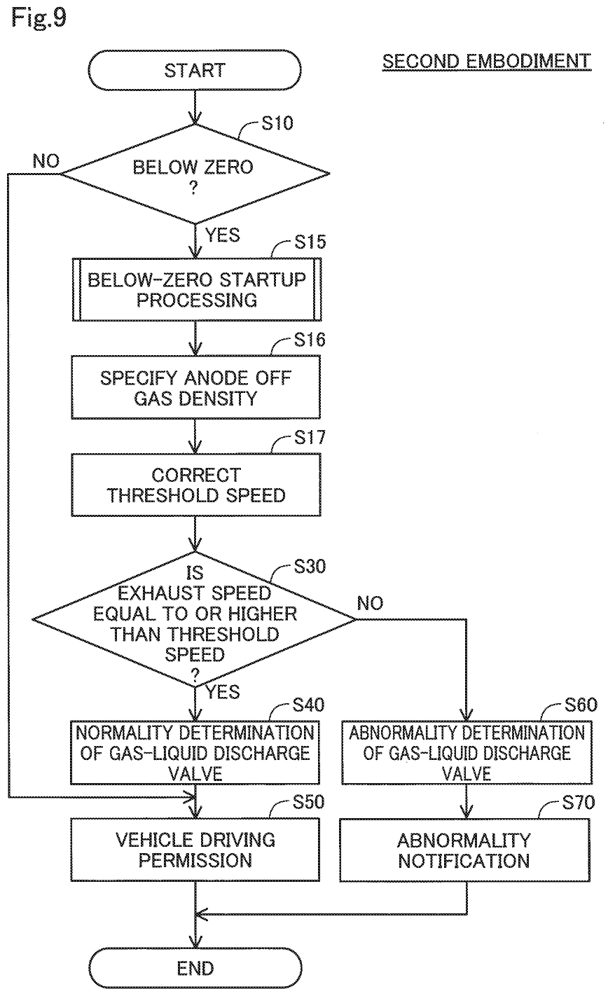

Here, molecular weights of the hydrogen gas, the nitrogen gas, and the water vapor are different, so that the gas density of the anode off gas varies depending on the composition. In general, if the gas density becomes higher, discharging the anode off gas becomes harder, which reduces the exhaust speed A. On the contrary, if the gas density becomes lower, discharging the anode off gas becomes easier, which increases the exhaust speed A. As described above, since the compositions of the anode off gas are different between the warmed-up state and the below-zero startup, the difference in the compositions causes a difference in the exhaust speed A. Therefore, if the valve opening determination is performed at the below-zero startup using the threshold speed updated in the warmed-up state, the determination accuracy may decrease. Accordingly, in the fuel cell system 10 in the second embodiment, when the threshold speed updated in the threshold speed updating processing is used in the normal valve opening determination processing, the control device 60 performs the correction processing based on the density of the anode off gas before use. Detailed procedures are described hereinafter with reference to FIGS. 8 and 9.

FIG. 8 is a flowchart illustrating the threshold speed updating processing according to the second embodiment. The threshold speed updating processing in the second embodiment is different from the threshold speed updating processing in the first embodiment shown in FIG. 6 in that a step S155 is additionally executed. Other procedures of the threshold speed updating processing in the second embodiment are the same as those of the threshold speed updating processing in the first embodiment, and thus the same procedures are denoted with the same reference numerals and detailed descriptions thereof will be omitted.

After the step S150 is executed and the exhaust speed is obtained, the threshold speed setting unit 69 specifies the density of the anode off gas and stores it in the memory 64 (step S155). After the execution of the step S155, the step S160 described above is executed. Note that the gas density specified in the step S155, that is, the gas density of the anode off gas in the warmed-up state is referred to as the gas density ρ1 in the present embodiment. A method for specifying the gas density ρ1 is described hereinafter.

The gas density ρ1 of the anode off gas in the warmed-up state is calculated by Formula (5) below:

ρ1={(n_{H2}×M_{H2})+(n_{N2}×M_{N2})+(n_{H2O}×M_{H2O}}}/V Formula (5)

In the Formula (5), V represents the same as V in the forgoing Formula (3). n_{H2} represents the number of moles of the hydrogen gas existing in the fuel gas supply path 501 on the downstream side of the injector 54, the fuel gas circulation path 502, and the gas-liquid separator 57 (hereinafter referred to as an “anode side circulation system area”). Similarly, n_{N2} represents the number of moles of the nitrogen gas in the anode side circulation system area, and n_{H2O} represents the number of moles of the water vapor in the anode side circulation system area. In addition, M_{H2} represents molecular weight of the hydrogen gas, M_{N2} represents molecular weight of the nitrogen gas, and M_{H2O} represents molecular weight of the water vapor.

The number of moles of the water vapor n_{H2O} is expressed by Formula (6) below based on a gas state equation:

n_{H2O}=(P_{H2O}×V)/(R×T) Formula (6)

In the Formula (6), P_{H2O} represents the partial pressure of the water vapor, R represents a gas constant (8.314[J/K·mol]), and T represents the coolant temperature. P_{H2O} can be considered to be equal to the saturated water vapor pressure in the warmed-up state. A table of relation between the coolant temperature and the saturated water vapor pressure is previously stored in the memory 64, and the threshold speed setting unit 69 refers to the table to obtain the saturated water vapor pressure based on a measured value of the temperature sensor 73. Then, the obtained saturated water vapor pressure is substituted for P_{H2O} in the forgoing Formula (6) to calculate the number of moles of the water vapor n_{H2O}.

In the present embodiment, the number of moles of the nitrogen gas n_{N2} in the anode side circulation system area is periodically calculated using Formula (7) below by the threshold speed setting unit 69:

[Math 1]

n_{N2}(t+1)=n_{N2}(t)+∫ₜ^{t+1}Q_{Nin} dt−b(t)×∫ₜ^{t+1}Qₑₓ₁dt Formula (7)

In the Formula (7), n_{N2}(t+1) represents the number of moles of the nitrogen gas at (t+1)th calculation time. In addition, n_{N2}(t) represents the number of moles of the nitrogen gas at (t)th calculation time. Furthermore, Q_{Nin} represents an inflow rate of the nitrogen gas into the anode side circulation system area per unit time. Furthermore, Qₑₓ₁ represents a total quantity of gas discharged from the anode side circulation system area per unit time, that is, the exhaust speed A of the gas. Furthermore, a coefficient b(t) represents a proportion of the nitrogen gas in the gas discharged from the anode side circulation system area at the (t)th calculation time.

Q_{Nin} represents the inflow rate of the nitrogen gas into the anode side circulation system area per unit time, and it is a value previously specified from a physical property of the electrolyte membrane or the like included in each of the unit cells 151 or the like. In the present embodiment, the value is previously stored in the memory 64, and the threshold speed setting unit 69 substitutes the value in the Formula (7). Qₑₓ₁ means the exhaust speed A obtained in the step S30 of the normal valve opening determination processing described above. In the present embodiment, the coefficient b(t) is periodically calculated using Formula (8) below by the threshold speed setting unit 69:

b(t)=n_{N2}(t)/nₐₗₗ(t) Formula (8)

In the Formula (8), b(t−1) represents the coefficient b at a previous (t−1)th calculation time. In addition, nₐₗₗ(t) represents a total number of moles of the gas discharged from the anode side circulation system area per unit time at the (t)th calculation time, and it is calculated using Qₑₓ₁ and the gas state equation. Qₑₓ₁(t−1) represents the total quantity of the gas Qₑₓ₁ discharged from the anode side circulation system area per unit time at the previous (t−1)th calculation time. Note that a value of the coefficient b calculated at the end before the fuel cell system 10 is stopped last time is used for b(1), that is, an initial value of the coefficient b(t) in the present embodiment. In addition, in a configuration in which the proportion of the nitrogen in the atmosphere is calculated or where the coefficient b is continuously calculated while the fuel cell system 10 is stopped, the latest calculated value may be used instead of the aforementioned value.

The number of moles of the hydrogen gas n_{H2} is expressed by Formula (9) below based on the gas state equation:

n_{H2}=(P_{H2}×V)/(R×T) Formula (9)

In the Formula (9), P_{H2} represents the partial pressure of the hydrogen gas, R represents the gas constant (8.314[J/K·mol]), and T represents the coolant temperature. Here, the partial pressure of the hydrogen gas P_{H2} is calculated by Formula (10) below:

P_{H2}=Pₐₗₗ−(P_{N2}+P_{H2O}) Formula (10)

In the Formula (10), Pₐₗₗ represents the total pressure. The partial pressure of the nitrogen gas P_{N2} can be calculated using the number of moles of the nitrogen gas obtained by the foregoing Formula (7) and the gas state equation. As described above, P_{H2O} can be considered as the saturated water vapor pressure in the warmed-up state. The threshold speed setting unit 69 substitutes the saturated water vapor pressure for P_{H2O} in the Formula (10) and the calculated partial pressure of the nitrogen gas P_{N2} in the Formula (10) so as to calculate the partial pressure of the hydrogen gas P_{H2}. The partial pressure of the hydrogen gas P_{H2} calculated as described above is substituted in the Formula (9) so as to calculate the number of moles of the hydrogen gas n_{H2}.

The number of moles of the hydrogen gas n_{H2} calculated as described above, the number of moles of the nitrogen gas n_{N2}, the number of moles of the water vapor n_{H2O}, the molecular weight of each of the gases, and the volume V of the anode side circulation system area are substituted in the Formula (5) so as to calculate and specify the gas density ρ1 of the anode off gas in the warmed-up state. Note that the molecular weight of each of the gases is previously stored in the memory 64.

FIG. 9 is a flowchart illustrating a normal valve opening determination processing according to the second embodiment. The normal valve opening determination processing in the second embodiment is different from the normal valve opening determination processing in the first embodiment shown in FIG. 3 in that steps S16 and S17 are additionally executed. Other procedures of the normal valve opening determination processing in the second embodiment are the same as those in the first embodiment, and thus the same procedures are denoted with the same reference numerals and detailed descriptions thereof will be omitted.

After the below-zero startup processing (step S15) is executed, the gas-liquid discharge valve normality determination unit 68 specifies the gas density of the anode off gas (step S16). The gas density specified in the step S16, that is, the gas density of the anode off gas at the below-zero startup is referred to as the gas density ρ0 in the present embodiment. A method for specifying the gas density ρ0 is the same as the aforementioned method for specifying the gas density ρ1, and thus detailed descriptions thereof will be omitted. However, the anode off gas at the below-zero startup includes approximately the hydrogen gas and the nitrogen gas only, as described with reference to FIG. 7. The water vapor is included only to the extent that it can be ignored. Therefore, parameters pertaining to the water vapor in the forgoing Formulas (5) to (10) are omitted.

The gas-liquid discharge valve normality determination unit 68 corrects the threshold speed using the gas density ρ1 stored in the memory 64 and the gas density ρ0 specified in the step S16 (step S17). The exhaust speed A (Qₑₓ) of the anode off gas discharged from the gas-liquid discharge valve 58 is proportional to a square root of a reciprocal of the gas density. Accordingly, assuming that the exhaust speed A2 at the below-zero startup is Qₑₓ₀ and the exhaust speed B at execution time of the threshold speed updating processing is Qₑₓ₁, Formula (11) below is established with regard to these two exhaust speeds A.

$$\begin{matrix}[ Math 2 ] & \\ {Q}_{ex 0} = α \times {Q}_{ex 1} \times \sqrt{\frac{ρ1}{ρ 0}} & Formula ( 11 )\end{matrix}$$

In the Formula (11) described above, α is a constant, which is previously obtained by experiment or the like and stored in the memory 64. The control device 60 substitutes the gas density ρ1 stored in the memory 64, the threshold speed Qₑₓ₁, and the constant α, in the forgoing Formula (11). Furthermore, the control device 60 substitutes the gas density ρ0 specified in the step S16 so as to correct the threshold speed Qₑₓ₁ and calculate the threshold speed Qₑₓ₀ at the below-zero startup.

After the threshold speed is corrected in such a manner, the procedures in and after the step S30 described above are executed as shown in FIG. 9. Therefore, in the normal valve opening determination in the step S30, the calculated exhaust speed A2 is compared with the corrected threshold speed Qₑₓ₀. According to the second embodiment described above, in the step S17 of the normal valve opening determination processing, the correction processing is executed on the threshold speed set in the threshold speed updating processing. Accordingly, the exhaust speed B is corrected so that first gas density that is gas density corresponding to the exhaust speed A2 can match second gas density that is gas density corresponding to the exhaust speed B serving as the threshold speed in the step S150 of the threshold speed updating processing.

The fuel cell system 10 in the second embodiment described above can provide the same advantageous effects as those of the fuel cell system 10 in the first embodiment. In addition, in the normal valve opening determination processing, the correction processing for correcting the exhaust speed B is executed so that the first gas density of the exhaust speed A2 can match the second gas density of the exhaust speed B. Therefore, it is possible to cancel out a variation of the exhaust speed caused by a difference between the compositions of the anode off gas at the time when the exhaust speed B serving as the threshold speed is obtained and at the time when the exhaust speed A2 is obtained so as to enhance the determination accuracy of the normal valve opening determination processing.

### C. Alternative Embodiments

The configurations of the fuel cell system 10 in the foregoing embodiments are only examples and may be modified in various ways.

(C1) In the foregoing embodiments, the exhaust speed acquisition unit 66 uses the amount of change in the gas pressure measured by the pressure sensor 59 to calculate the exhaust speed A (Qₑₓ); however, the present disclosure is not limited to this. For example, a flowmeter may be disposed near an outlet of the gas-liquid discharge valve 58 in the gas-liquid discharge path 504, and the exhaust speed acquisition unit 66 may obtain the exhaust speed A (Qₑₓ) using a measured value by the flowmeter. That is, in general, any exhaust speed acquisition unit 66 may be used in the fuel cell system 10 of the present disclosure as long as it can obtain the exhaust speed of the anode off gas exhausted from the gas-liquid discharge valve 58 in an appropriate way.

(C2) In the forgoing embodiments, the exhaust speed A1 is obtained once in the step S150 of the threshold speed updating processing to calculate the threshold speed based on it, and the threshold speed is updated in the step S160 with the threshold speed thus calculated; however, the present disclosure is not limited to this. For example, the exhaust speed A1 may be obtained multiple times in the step S150, and the threshold speed may be updated in the step S160 with the threshold speed calculated based on the highest exhaust speed A1 of all. Furthermore, for example, if the step S150 is executed multiple times between a startup and a stop of the fuel cell system 10, the threshold speed may be updated in the step S160 with the threshold speed calculated based on the highest exhaust speed A1 of all obtained multiple times. Such a configuration may include procedures, for example, to calculate the threshold speed based on the obtained exhaust speed A1 at every time the step S150 is executed, to update the threshold speed if the calculated threshold speed is higher than the threshold speed stored in the memory 64, and not to update if it is lower. With these configurations, it is possible to use, as a basis of the threshold speed, the exhaust speed A1 at the time when an amount of liquid water (liquid state water) discharged from the gas-liquid discharge valve 58 is the least and a period during which the discharge of the anode off gas is suppressed due to the discharge of the liquid water during an opening period of the gas-liquid discharge valve 58 is the shortest. Accordingly, the exhaust speed A1 as an actual capability of the gas-liquid discharge valve 58 in the normal state can be measured more accurately, thereby enabling more accurate determination of whether the gas-liquid discharge valve 58 is open normally.

(C3) In the forgoing second embodiment, the exhaust speed B is corrected so that the comparison between the exhaust speed B and the exhaust speed A2 is made when the density of the anode off gas at the time when the exhaust speed B is obtained matches the density of the anode off gas at the time when the exhaust speed A2 is obtained; however, the present disclosure is not limited to this. For example, only the exhaust speed A2 may be corrected out of the exhaust speed A2 and the exhaust speed B so as to make a comparison between the exhaust speed A2 and the exhaust speed B in a case of the densities of the anode off gas being matched. In such a configuration, the step S155 may be omitted, the exhaust speed A2 obtained in the step S150 may be corrected using the Formula (11) described above in the step S160, and the corrected exhaust speed A2 may be updated as the threshold speed (exhaust speed B) in the step S160. In this case, as the gas density ρ0 of the anode off gas at the below-zero startup, an assumed value may be previously stored in the memory 64 to use. In addition, in such a configuration, the steps S16 and S17 of the normal valve opening determination processing may be omitted.

Moreover, for example, both the exhaust speed A2 and the exhaust speed B may be corrected so as to make a comparison between the exhaust speed A2 and the exhaust speed B in the case of the densities of the anode off gas being matched. In such a configuration, for example, a gas density ρ2 in a predetermined state different from the warmed-up state and a state at the below-zero startup (hereinafter referred to as a “third state”) is previously specified. Then, the exhaust speed A2 and the exhaust speed B are respectively converted into the exhaust speed in the third state, and the converted exhaust speed A2 and the converted exhaust speed B may be compared. Such a conversion may be performed using the Formula (11) described above. In addition, in this case, as the constant α, a constant used for converting between the third state and the warmed-up state and a constant used for converting between the third state and the state at the below-zero startup may be previously calculated by experiment or the like and used.

(C4) At least part of the steps S110, S120, and S130 in the threshold speed updating processing in the forgoing embodiments may be omitted. In addition, these steps S110 to S130 may be processed actively to obtain affirmative determination results (YES). For example, the number of revolutions of the coolant circulation pump 74 may be controlled so that it can be determined that the coolant temperature is constant in the step S110. Alternatively, the number of revolutions of the circulation pump 55 may be controlled so that it can be determined that the anode circulation flow rate is constant in the step S120. Alternatively, the injection by the injector 54 may be actively stopped so that it can be determined that the injection by the injector 54 is stopped in the step S130.

(C5) In the threshold speed updating processing in the forgoing embodiments, whether the fuel cell 15 is in the warmed-up state is determined depending on whether the coolant temperature is equal to or higher than the predetermined temperature; however, the present disclosure is not limited to this. For example, a temperature sensor may be disposed near the gas-liquid discharge valve 58. It may be determined that the fuel cell 15 is in the warmed-up state if a measured value by the temperature sensor is equal to or higher than predetermined temperature. Alternatively, for example, a water gauge may be disposed to the gas-liquid separator 57. It may be determined that the fuel cell 15 is in the warmed-up state if a measured value by the water gauge is equal to or higher than a predetermined water level. Generally speaking, in the warmed-up state, the fuel cell 15 is generating electricity, so that water generated in the electrochemical reaction in each of the plurality of unit cells 151 is discharged and accumulated in the gas-liquid separator 57. Accordingly, the water level in the gas-liquid separator 57 becomes high in the warmed-up state, and thus the determination of the warmed-up state can be made by the water level.

(C6) In the foregoing embodiments, the water vapor partial pressure is considered to be equal to the saturated water vapor pressure when the density of the anode off gas is specified; however, the present disclosure is not limited to this. For example, a dew point meter may be disposed near an outlet of the gas-liquid discharge valve 58 in the gas-liquid discharge path 504 so as to obtain the water vapor partial pressure P_{H2O} using a measured value by the dew point meter. Alternatively, measured results previously obtained experimentally may be stored in the memory 64 so that the water vapor partial pressure P_{H2O} can be obtained based on the stored results.

(C7) In the foregoing embodiments, the fuel cell system 10 is installed in the fuel cell vehicle and used as a system for supplying electricity to the drive motor; however, the present disclosure is not limited to this. For example, it may be installed and used in any other moving body that requires a driving power source, instead of the fuel cell vehicle. Alternatively, it may be used as a stationary power source. Furthermore, each of the unit cells 151 included in the fuel cell 15 is a unit cell for a polymer electrolyte fuel cell; however, it may be a unit cell for various kinds of fuel cells such as a phosphoric acid fuel cell, a molten carbonate fuel cell, and a solid oxide fuel cell.

(C8) The configurations implemented by hardware in the foregoing embodiments may be partially replaced with software. Conversely, the configurations implemented by software in the foregoing embodiments may be partially replaced with hardware. For example, at least part of functions of the controller 62 may be implemented with an integrated circuit, a discrete circuit, or a module combining these circuits. Moreover, if the functions according to the present disclosure are partially or entirely implemented by software, the software (computer program) can be provided while being stored in a computer-readable storage medium. This “computer-readable storage medium” is not limited to portable recording media, such as a flexible disk and a CD-ROM, but includes various internal storage devices such as a RAM and a ROM in a computer and various external storage devices such as a hard disk fixed to a computer. Thus, the “computer-readable storage medium” has a broad meaning including any storage medium that can hold data packets in a non-transitory manner.

The present disclosure is not limited to the foregoing embodiments and can be implemented in various ways without departing from the spirit and scope of the present disclosure. For example, the technical features that are described in each of the embodiments and correspond to those of the aspects descried in the SUMMARY section can be replaced and combined as appropriate to partially or entirely solve the problem described above, or partially or entirely achieve the effects described above. The technical features that are not described as an essential feature in the specification can be omitted as appropriate. For example, the present disclosure may be implemented in aspects described below.

(1) According to one aspect of the present disclosure, there is provided a fuel cell system. The fuel cell system comprises a fuel cell, coolant configured to adjust temperature of the fuel cell, a gas-liquid separator configured to separate gas and moisture included in anode off gas discharged from the fuel cell, a gas-liquid discharge valve disposed downstream of the gas-liquid separator and configured to control discharge of the moisture from the gas-liquid separator, and a controller. The controller includes an exhaust speed acquisition unit configured to obtain an exhaust speed of the anode off gas discharged from the gas-liquid discharge valve as an exhaust speed A, a threshold speed setting unit configured to set an exhaust speed B, serving as a threshold speed, based on an exhaust speed A1 that is the exhaust speed A obtained by the exhaust speed acquisition unit in a warmed-up state in which temperature of the coolant is equal to or higher than predetermined temperature, and a gas-liquid discharge valve normality determination unit configured to compare an exhaust speed A2, which is the exhaust speed A at a time after the exhaust speed B is set by the threshold speed setting unit and when environmental temperature is below zero, with the exhaust speed B so as to perform a normal valve opening determination to determine whether the gas-liquid discharge valve opens normally.

According to this aspect, executing the normal valve opening determination of the gas-liquid discharge valve using the exhaust speed results in an accurate determination of whether the gas-liquid discharge valve opens normally. For example, the accurate determination can be made when the gas-liquid discharge valve does not operate normally due to a reason other than freezing. Moreover, the threshold speed setting unit sets the exhaust speed B serving as the threshold speed based on the exhaust speed A1 obtained by the exhaust speed acquisition unit. Therefore, compared with a configuration in which the threshold speed is previously set to a predetermined value, it is possible to suppress the decrease in the determination accuracy of whether the gas-liquid discharge valve normally opens when an individual difference or aging of the gas-liquid discharge valve occurs. For example, compared with a configuration in which a predetermined value is previously set as the threshold speed even though the design tolerance causes a variation in opening areas of a plurality of gas-liquid discharge valves or a configuration in which a predetermined value previously set as the threshold speed is continuously used even though the opening area is reduced due to aging such as adhesion of dirt to the opening of the gas-liquid discharge valve, the decrease in the determination accuracy can be suppressed. Furthermore, the exhaust speed that is a basis of the threshold speed to be set is the exhaust speed A1 obtained in the warmed-up state. Therefore, the threshold speed can be set based on the exhaust speed A1 obtained when the freezing of the gas-liquid discharge valve is suppressed. Accordingly, the threshold speed can be set based on the exhaust speed A1 at the time when the gas-liquid discharge valve does not freeze and can open normally, thereby suppressing the decrease of the determination accuracy of whether the gas-liquid discharge valve opens normally. Moreover, the saturated water vapor pressure increases exponentially with temperature. Accordingly, if the temperature of the coolant of the fuel cell becomes equal to or higher than the predetermined temperature and the fuel cell becomes the warmed-up state in which the fuel cell is considered to be warmed up, an amount of water vapor that can be included in the discharged gas increases. Therefore, in the warmed-up state, most of water discharged from the fuel cell is discharged as water vapor, and thus discharging liquid water from the gas-liquid discharge valve is suppressed. Accordingly, it is possible to suppress obtaining the exhaust speed A1, serving as the basis of the threshold speed, when the exhaust speed is lower than the actual capability value of the gas-liquid discharge valve because the liquid water discharged from the gas-liquid discharge valve prevents the gas from being exhausted. Therefore, an accurate value can be set as the threshold speed.

(2) In the fuel cell system in the forgoing aspect, the exhaust speed acquisition unit may obtain the exhaust speed A1 multiple times in the warmed-up state, and the threshold speed setting unit may set a highest value of the multiple exhaust speeds A1 obtained by the exhaust speed acquisition unit as the exhaust speed B in the warmed-up state.

According to this aspect, the highest value of the multiple exhaust speeds A1 obtained by the exhaust speed acquisition unit is set as the exhaust speed B. Accordingly, the exhaust speed B can be set to the exhaust speed with a higher possibility that a foreign substance such as ice does not exist in the gas-liquid discharge valve, or that water accumulated in the gas-liquid separator is not discharged as liquid water and the exhaust speed is not reduced by the discharged water. Therefore, it is possible to more accurately determine whether the gas-liquid discharge valve is open normally.

(3) In the fuel cell system in the forgoing aspects, the threshold speed setting unit may set the exhaust speed B based on a lowest value of the exhaust speeds calculated using design tolerance of the gas-liquid discharge valve at a first startup of the fuel cell system.

When parts of the gas-liquid discharge valve or the like are manufactured, an individual difference within the design tolerance occurs. Accordingly, the opening area of the gas-liquid discharge valve has a variation. However, according to the forgoing aspect, the threshold speed is set based on the lowest value of the exhaust speed calculated using the design tolerance, thereby suppressing an erroneous determination that the gas-liquid discharge valve is blocked even when it is in the normal sate, even if the opening area of the gas-liquid discharge valve is the smallest.

(4) In the fuel cell system in the forgoing aspects, the controller can execute correction processing before the normal valve opening determination. In the correction processing, at least one of the exhaust speed A2 and the exhaust speed B may be corrected so as to match first gas density that is gas density of the anode off gas corresponding to the exhaust speed A2 and second gas density that is gas density of the anode off gas corresponding to the exhaust speed B.

The composition of the anode off gas varies depending on temperature of the anode off gas and a state of the fuel cell. An average molecular weight of the anode off gas varies depending on the variation of the composition of the anode off gas, and thus the exhaust speed A varies. However, according to the foregoing aspect, the processing for correcting at least one of the exhaust speed A2 and the exhaust speed B is executed so that the density of the anode off gas corresponding to the exhaust speed A2 and the density of the anode off gas corresponding to the exhaust speed B can match. Thus, it is possible to cancel out the variation of the exhaust speed A caused by a difference between the compositions of the anode off gas at the time when the exhaust speed A2 is obtained and at the time when the exhaust speed B is obtained. Consequently, the determination accuracy of the normal valve opening determination can be enhanced.

(5) According to the forgoing aspects, the fuel cell system further comprises a pressure sensor configured to measure gas pressure in a fuel gas supply path through which fuel gas is supplied to the fuel cell, and the exhaust speed acquisition unit calculates the exhaust speed A using an amount of change in the gas pressure measured by the pressure sensor.

According to this aspect, the exhaust speed is calculated using the amount of change in the gas pressure measured by the pressure sensor. Therefore, in the configuration in which the measured value by the pressure sensor is used for control of the fuel cell system other than the normal valve opening determination and setting of the exhaust speed B, no additional device is required to obtain the exhaust speed. As a result, manufacturing costs for the fuel cell system can be reduced.

(6) The fuel cell system further comprises a fuel gas circulation flow path connected to the fuel gas supply path and configured to supply the fuel cell with the anode off gas that has come out of the gas-liquid separator, an injector disposed in the fuel gas supply path and configured to supply the fuel gas, and a fuel gas circulation pump disposed in the fuel gas circulation flow path and configured to supply the anode off gas to the fuel cell. The threshold speed setting unit calculates the exhaust speed A based on the amount of change in the gas pressure measured by the pressure sensor while the gas-liquid discharge valve is open, the number of revolutions of the fuel gas circulation pump is constant, and supply of the fuel gas by the injector to the fuel gas supply path is stopped.

According to this aspect, the exhaust speed is calculated using the amount of change of the gas pressure measured by the pressure sensor while the gas-liquid discharge valve is open, the number of revolutions of the circulation pump is constant, and the supply of the fuel gas to the fuel gas supply path by the injector is stopped. Therefore, the exhaust speed can be calculated using the amount of change in the gas pressure measured when the number of factors that vary the gas pressure in the fuel gas supply path is small. Accordingly, the exhaust speed can be calculated more accurately, and the determination of whether the gas-liquid discharge valve is open normally can be made more accurately.

The present disclosure may be implemented in various aspects other than those described above such as a vehicle equipped with a fuel cell system, a method for controlling the fuel cell system, a method for determining normality of the gas-liquid discharge valve, a computer program for implementing these methods, and a storage medium storing the computer program.

What is claimed is:

1. A fuel cell system comprising:
a fuel cell;
coolant configured to adjust temperature of the fuel cell;
a gas-liquid separator configured to separate gas and moisture included in anode off gas discharged from the fuel cell;
a gas-liquid discharge valve disposed downstream of the gas-liquid separator and configured to control discharge of the moisture from the gas-liquid separator; and
a controller, wherein
the controller includes
an exhaust speed acquisition unit configured to obtain an exhaust speed of the anode off gas discharged from the gas-liquid discharge valve as an exhaust speed A,
a threshold speed setting unit configured to set an exhaust speed B, serving as a threshold speed, based on an exhaust speed A1 that is the exhaust speed A obtained by the exhaust speed acquisition unit in a warmed-up state in which temperature of the coolant is equal to or higher than predetermined temperature, and
a gas-liquid discharge valve normality determination unit configured to compare an exhaust speed A2, which is the exhaust speed A at a time after the exhaust speed B is set by the threshold speed setting unit and when environmental temperature is below zero, with the exhaust speed B so as to perform a normal valve opening determination to determine whether the gas-liquid discharge valve opens normally.

2. The fuel cell system according to claim 1,
wherein the exhaust speed acquisition unit obtains the exhaust speed A1 multiple times in the warmed-up state, and
wherein the threshold speed setting unit sets a highest value of the multiple exhaust speeds A1 obtained by the exhaust speed acquisition unit as the exhaust speed B.

3. The fuel cell system according to claim 1, wherein the threshold speed setting unit sets the exhaust speed B based on a lowest value of the exhaust speeds calculated using design tolerance of the gas-liquid discharge valve at a first startup of the fuel cell system.

4. The fuel cell system according to claim 1, wherein the controller is configured to execute correction processing before the normal valve opening determination, the correction processing correcting at least one of the exhaust speed A2 and the exhaust speed B so as to match first gas density that is gas density of the anode off gas corresponding to the exhaust speed A2 and second gas density that is gas density of the anode off gas corresponding to the exhaust speed B.

5. The fuel cell system according to claim 1 further comprising a pressure sensor configured to measure gas pressure in a fuel gas supply path through which fuel gas is supplied to the fuel cell,
wherein the exhaust speed acquisition unit calculates the exhaust speed A using an amount of change in the gas pressure measured by the pressure sensor.

6. The fuel cell system according to claim 5 further comprising a fuel gas circulation flow path connected to the fuel gas supply path and configured to supply the fuel cell with the anode off gas that has come out of the gas-liquid separator, an injector disposed in the fuel gas supply path and configured to supply the fuel gas, and a fuel gas circulation pump disposed in the fuel gas circulation flow path and configured to supply the anode off gas to the fuel cell,
wherein the threshold speed setting unit calculates the exhaust speed A based on the amount of change in the gas pressure measured by the pressure sensor while the gas-liquid discharge valve is open, the number of revolutions of the fuel gas circulation pump is constant, and supply of the fuel gas by the injector to the fuel gas supply path is stopped.
